(19) United States
(12) Patent Application Publication
(10) Pub. No.: US 2026/0084205 A1
(43) Pub. Date: Mar. 26, 2026

(54) Semi-Truck Brake Shoe Riveter

(71) Applicant: James Stengel, Marion, IN (US)

(72) Inventor: James Stengel, Marion, IN (US)

(21) Appl. No.: 18/896,172

(22) Filed: Sep. 25, 2024

(51) Int. Cl. B21J 15/14; B21J 15/20; B21J 15/28; B21J 15/32; F16D 65/00

(52) U.S. Cl. CPC B21J 15/14; B21J 15/20; B21J 15/28; B21J 15/32; F16D 65/0043

(57) ABSTRACT

A semi-truck brake shoe riveter configured to simultaneously rivet an opposing pair of semi-truck brake shoes without requiring assistance from others besides a main operator of the semi-truck brake shoe riveter. The semi-truck brake shoe riveter is automated and utilizes a double brake shoe riveter configuration. The double brake shoe riveter configuration is moved into place to precisely rivet a pair of brake shoes to a pair of brake shoe tables with two pairs of hydraulic rams and two pairs of precisely automatic riveter anvils. The two pairs of hydraulic rams include sensors to detect unaligned rivets to precisely rivet the pair of brake shoes to the pair of brake shoes tables. The semi-truck brake shoe riveter also accommodates regenerative semi-truck brakes.

### BACKGROUND OF THE INVENTION

The present invention relates to a brake shoe riveter. More particularly, the present invention relates to a semi-truck brake shoe riveter.

Setting rivets in drum-type brake shoes for semi-trucks is typically done through semi-automatic machines. This process is high in labor costs and may be difficult and frustrating. Brake shoe riveting machines exist for semi-trucks but only rivet one brake shoe at a time, and require assistance from others besides the main operator of the semi-truck brake shoe riveter.

In order to address these concerns, the present invention provides a semi-truck brake shoe riveter configured to simultaneously rivet an opposing pair of semi-truck brake shoes without requiring assistance from others besides the main operator.

### SUMMARY OF THE INVENTION

In view of the foregoing disadvantages inherent in the types of semi-truck brake shoe riveters and similar devices now present in the known art, the present invention provides a semi-truck brake shoe riveter configured to simultaneously rivet an opposing pair of semi-truck brake shoes without requiring assistance from others besides the main operator.

The present invention relates to a brake shoe riveter. More particularly, the present invention relates to a semi-truck brake shoe riveter.

One embodiment of the semi-truck brake shoe riveter comprises a housing adapted to stand on a floor, a powered exit conveyor unloading a plurality of new drum brakes from the housing, a programmable logic control system having a panel-mounted display with a touch screen, a plurality of operational safety buttons including an extended emergency stop button and an extended and widened activation button disposed on an exterior portion of the housing adapted to be in front of an operator, a machine carriage rotating and moving horizontally to precisely align each of a plurality of brake shoe tables with a plurality of brake shoes, the brake shoe tables and the brake shoes are grasped and placed individually onto the machine carriage, and the brake shoe tables each includes a first plurality of holes that align with the brake shoes that each includes a second plurality of holes, a rivet hopper loading a plurality of rivets to the machine carriage, a plurality of hydraulic cylinders driving a plurality of rams downward, and a plurality of automated riveter anvils driving into each of the rams on the brake shoe tables that roll, torque, or crimp the rivets to attach each of the brake shoe tables to each of the brake shoes to produce the new drum brakes.

One object of the present invention is to provide a semi-truck brake shoe riveter that is configured to simultaneously rivet an opposing pair of semi-truck brake shoes without requiring assistance from others besides a main operator of the semi-truck brake shoe riveter.

One object of the present invention is to provide a semi-truck brake shoe riveter that includes a double brake shoe riveter configuration that is moved into place to precisely rivet a pair of brake shoes to a pair of brake shoes tables with two pairs of hydraulic rams and two pairs of precisely automatic riveter anvils.

One object of the present invention is to provide a semi-truck brake shoe riveter that precisely rivets the pair of brake shoes to the pair of brake shoes tables.

One object of the present invention is to provide a semi-truck brake shoe riveter that accommodates regenerative semi-truck brakes.

One object of the present invention is to provide a semi-truck brake shoe riveter that is relatively safer and more ergonomic for an operator than a traditional manual riveter.

Other objects, features, and advantages of the present invention will become apparent from the following description taken in conjunction with the accompanying figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front environmental perspective view of one embodiment of a semi-truck brake shoe riveter.

FIG. 1B shows a front environmental perspective view of one embodiment of the semi-truck brake shoe riveter in use.

FIG. 2A shows a side perspective view of one embodiment of a brake shoe table of the semi-truck brake shoe riveter.

FIG. 2B shows a side view of one embodiment of a brake shoe table of the semi-truck brake shoe riveter.

FIG. 2C shows a cross-sectional view of FIG. 2B along Line A-A of one embodiment of a brake shoe table of the semi-truck brake shoe riveter.

FIG. 2D shows an overhead view of one embodiment of a left hand brake shoe and a right hand brake shoe of the semi-truck brake shoe riveter.

FIG. 3A shows a front view and a cross-sectional perspective view of FIG. 3B along Line A-A of the front view of the automated riveter anvil.

FIG. 3B shows a front view and a cross-sectional perspective view of FIG. 3B along Line B-B of the front view of a traditional manual riveter anvil.

FIG. 4 shows a front perspective view of the ram, the machine carriage, the brake shoe table, the brake shoe, and the automated riveter anvil.

### DETAILED DESCRIPTION OF THE INVENTION

Reference is made herein to the attached figures. For the purposes of presenting a brief and clear description of the present invention, the preferred embodiment will be discussed as used for providing a semi-truck brake shoe riveter. The figures are intended for representative purposes only and should not be considered to be limiting in any respect.

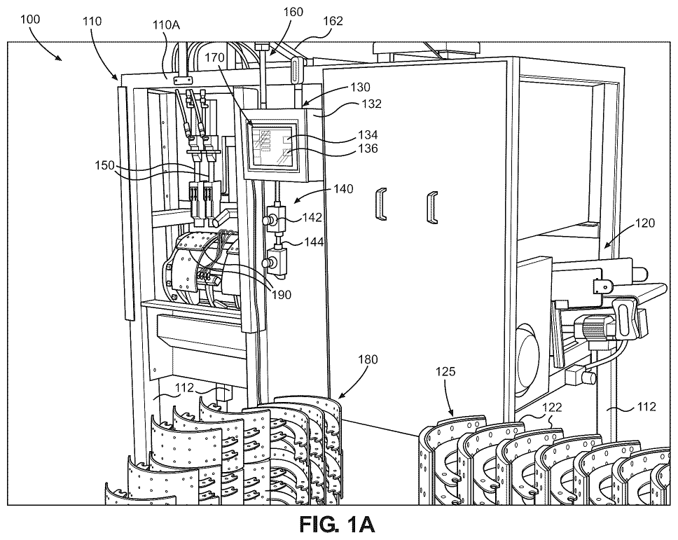

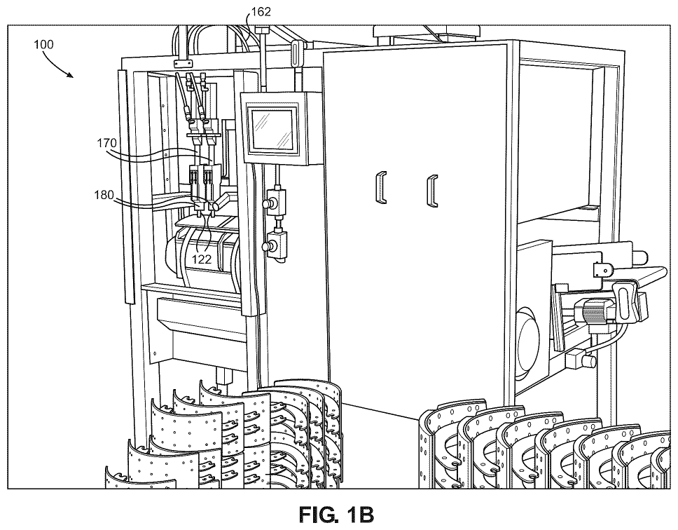

FIG. 1A shows a front environmental perspective view of one embodiment of a semi-truck brake shoe riveter 100.

The semi-truck brake shoe riveter 100 may include a housing 110, a powered exit conveyor 120, a Programmable Logic Control or PLC System 130, a plurality of operational safety buttons 140, a machine carriage 150, a rivet hopper 160, a plurality of rams 170, a plurality of brake shoe tables 180, and a plurality of automated riveter anvils 190.

The housing 110 may have a generally rectangular shape 110A and may be adapted to stand on a floor of a factory (not shown) from a plurality of legs 112 that extend to the floor or the like. The powered exit conveyor 120 may facilitate unloading of a plurality of new drum brakes 125 from the semi-truck brake shoe riveter 100 that may include throughputs up to approximately 200 brake shoes per hour with a relatively skilled operator and proper staging of materials. The PLC System 130 may be an Allen Bradley Programmable Logic Control 130A with a PanelView 800 Panel-Mounted Display Device 132 with a touch screen 134 that includes a plurality of numerous diagnostic tools 136 available on the PanelView 800 Panel-Mounted Display Device 132 with the touch screen 134. The operational safety buttons 140 may include a relatively extended emergency stop button 142 and a relatively extended and widened activation button 144 disposed on the exterior portion of the housing 110 in front of an operator that is relatively safer and more ergonomic than a traditional manual semi-truck brake shoe riveter or the like. The machine carriage 150 may accommodate riveting most standard approximate 7-inch wide brake shoes, approximate 8-inch wide brake shoes, and approximate 8-_{5/8}^{th} inch wide brake shoes or the like automatically. The rivet hopper 160 may have an approximate 1,000 lbs. capacity for a plurality of any type of rivets 162 or the like. The rams 170 may include two pairs of the rams 170 each having an approximate 10 Horsepower or HP hydraulic rower unit (not shown) with an approximate 7.4 Gallons Per Minute or GPM pressure compensated piston pump (not shown), an approximate 45-gallon reservoir (not shown) and a powered fan-type oil cooler (not shown) to create resistance. The brake shoe table 180 may include two pairs of brake shoe tables 180 with two pairs of brake shoes 122 that may be placed on the two pairs of brake shoe tables 180 to be rivetted to the two pairs of brake shoe tables 180. The automated riveter anvils 190 may include two pairs of automated anvils 190 that the rivets 162 are driven into from the rams 170 on the brake shoe tables 180 that may roll, torque, or crimp the rivets 162.

FIG. 1B shows a front environmental perspective view of one embodiment of a semi-truck brake shoe riveter 100 in use.

The brake shoe table 180 may include two pairs of brake shoe tables 180 with two pairs of brake shoes 122 that may be placed on the two pairs of brake shoe tables 180 to be rivetted to the two pairs of brake shoe tables 180. The automated riveter anvils 190 may include two pairs of automated anvils 190 that the rivets 162 are driven into from the rams 170 on the brake shoe tables 180 that may roll, torque, or crimp the rivets 162. The semi-truck brake shoe riveter 100 may accommodate regenerative brakes as well.

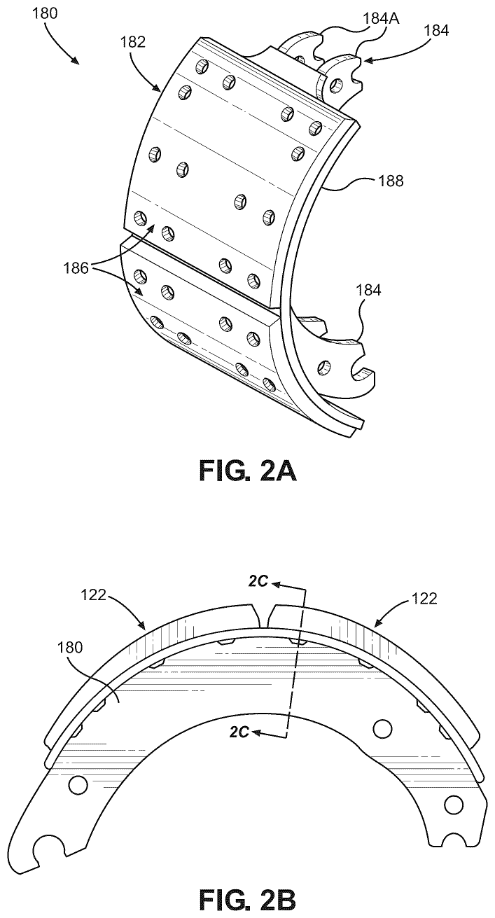

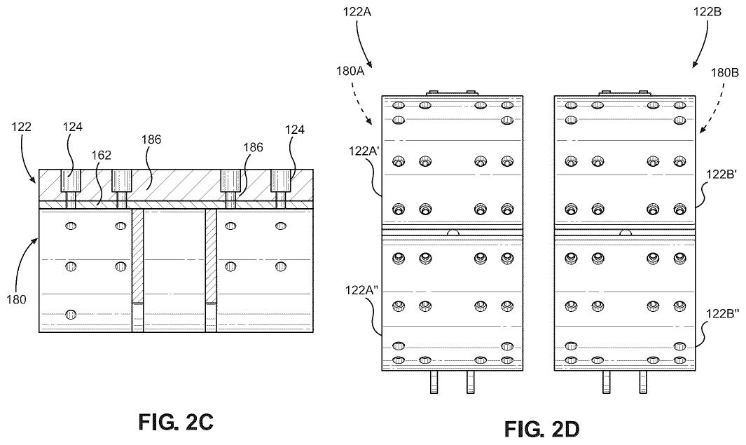

FIG. 2A shows a side perspective view of one embodiment of a brake shoe table 180 of the semi-truck brake shoe riveter 100.

The brake shoe table 180 may include a curved body 182, a pair of hooked ends 184, and a first plurality of holes 186.

The curved body 182 may have a first end and a second end. The pair of hooked ends 184 may be disposed on the first end and the second end of the curved body 182 and may each have a pair of hooks 184A that may attach the brake shoe table 180 to the machine carriage (FIGS. 1A, 150) of the semi-truck brake shoe riveter 100.

FIG. 2B shows a side view of one embodiment of a brake shoe table 180 of the semi-truck brake shoe riveter 100.

The brake shoe table 180 may be disposed below the brake shoe 122. Both the brake shoe table 180 and the brake shoe 122 are identically curved so that the brake shoe table 180 and the brake shoe 122 are flush against each other.

FIG. 2C shows a cross-sectional view of FIG. 2B along Line A-A of one embodiment of a brake shoe table 180 of the semi-truck brake shoe riveter 100.

The brake shoe table 180 may include the brake shoe 122 that may be placed on the brake shoe table 180 to be rivetted to the brake shoe table 180. The brake shoe table 180 may include the brake shoe 122 that may have a second plurality of holes 124 disposed on the brake shoes 122. The second holes 124 may be disposed in a predetermined pattern that receive the rivets (FIGS. 2D, 162) to be rolled, torqued, crimped, or the like to rivet the brake shoe table 180 and the brake shoes 122 together. The first holes (FIGS. 2A, 186) may align with the second holes 124 to receive the rivets 162 to be rolled, torqued, crimped, or the like to rivet the brake shoe table 180 and the brake shoes 122. The rivets 162 may be semi-tubular rivets or the like.

FIG. 2D shows an overhead view of one embodiment of a left hand brake shoe 122A riveted to a first brake shoe table 180A and a right hand brake shoe 122B riveted to a second brake shoe table 180B of the semi-truck brake shoe riveter (FIGS. 1A, 100).

The left hand brake shoe 122A may include a first anchor pad 122A′ and a first cam pad 122A″. The right hand brake shoe 122B may include a first anchor pad 122B′ and a first cam pad 122B″. The left hand brake shoe 122A may be identical to the right hand brake shoe 122B.

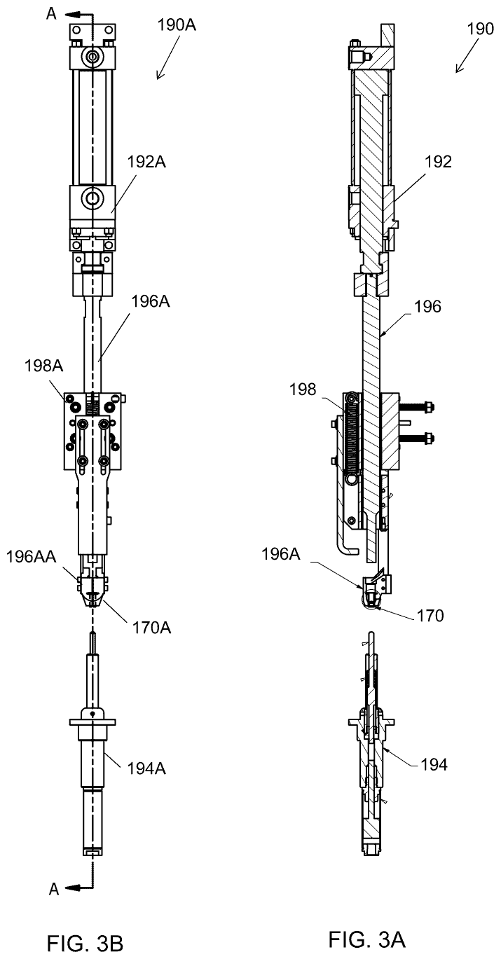

FIG. 3A shows a cross-sectional perspective view of FIG. 3B along Line A-A of the front view of the automated riveter anvil 190.

The automated riveter anvil 190 may include a pneumatic cylinder 192, a cylinder adaptor 194, an anvil shaft 196, and a spring 198.

The pneumatic cylinder 192 may provide drive to the automated riveter anvil 190. The cylinder adaptor 194 may be disposed into the pneumatic cylinder 192. The anvil shaft 196 may extend vertically from the cylinder adaptor 194 to make contact with the ram 170 at the distal end of the anvil shaft 196. The spring 198 may be disposed below the pneumatic cylinder 192 and is disposed in front of the anvil shaft 196 to provide tension to the anvil shaft 196 and a distal anvil surface 196A.

FIG. 3B shows a front perspective view of a traditional manual riveter anvil 190A.

The traditional manual riveter anvil 190A may include a pneumatic cylinder 192A, a cylinder adaptor 194A, an anvil shaft 196A, and a spring 198A.

The pneumatic cylinder 192A may provide drive to the automated riveter anvil 190A. The cylinder adaptor 194A may be disposed below the pneumatic cylinder 192A. The anvil shaft 196A may extend vertically from the cylinder adaptor 194A to make contact with the ram 170 at the distal end of the anvil shaft 196A. The spring 198A may be disposed within the pneumatic cylinder 192A and is disposed in front of the anvil shaft 196A to provide tension to the anvil shaft 196A and a distal anvil surface 196AA.

The traditional manual riveter anvil 190A may not be utilized with the semi-truck brake shoe riveter 100.

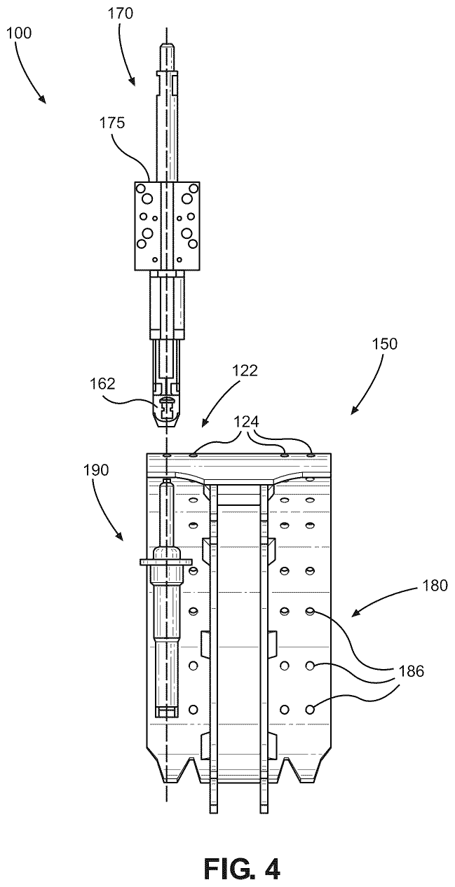

FIG. 4 shows a front perspective view of the ram (FIGS. 1A, 170), the machine carriage (FIGS. 2A, 150), the brake shoe table (FIGS. 1A, 180), the brake shoe (FIGS. 2A, 122), and the automated riveter anvil (FIGS. 1A, 190).

The ram 170 may be driven downward by a hydraulic cylinder 175 at approximately 1,400 to 1,800 pounds per square inch or PSI to form the rivet (FIGS. 2C, 162) on the automated riveter anvils 190. The machine carriage 150 may rotate and move horizontally to precisely align the first holes 186 of the brake shoe table 180 with the second holes 124 of the brake shoe 122. The brake shoe table 180 may be grasped and placed individually onto the machine carriage 150. The brake shoe 122 may be grasped and placed individually onto the machine carriage 150. The automated riveter anvil 190 may be disposed directly under the ram 170, each of the second holes 124 of the brake shoe 122, and each of the first holes 186 of the brake shoe table 180 to each receive the ram 170 to that roll, torque, or crimp the rivet 162.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A semi-truck brake shoe riveter, comprising:
a housing adapted to stand on a floor;
a powered exit conveyor unloading a plurality of new drum brakes from the housing;
a programmable logic control system having a panel-mounted display with a touch screen;
a plurality of operational safety buttons including an extended emergency stop button and an extended and widened activation button disposed on an exterior portion of the housing adapted to be in front of an operator;
a machine carriage rotating and moving horizontally to precisely align each of a plurality of brake shoe tables with a plurality of brake shoes, the brake shoe tables and the brake shoes are grasped and placed individually onto the machine carriage, and the brake shoe tables each includes a first plurality of holes that align with the brake shoes that each includes a second plurality of holes;
a rivet hopper loading a plurality of rivets to the machine carriage;
a plurality of hydraulic cylinders driving a plurality of rams downward; and
a plurality of automated riveter anvils driving into each of the rams on the brake shoe tables that roll, torque, or crimp the rivets to attach each of the brake shoe tables to each of the brake shoes to produce the new drum brakes.

2. The semi-truck brake shoe riveter, according to claim 1, wherein the housing includes a plurality of legs that extend to the floor.

3. The semi-truck brake shoe riveter, according to claim 1, wherein the semi-truck brake shoe riveter accommodates regenerative brakes.

4. The semi-truck brake shoe riveter, according to claim 1, wherein the rivets are a plurality of semi-tubular rivets.

5. The semi-truck brake shoe riveter, according to claim 1, wherein each of the rams includes a rivet jaw that holds one of the rivets from the rivet hopper.

6. The semi-truck brake shoe riveter, according to claim 1, wherein the hydraulic cylinders are 1,400 to 1,800to form the rivet on the automated riveter anvils.

7. The semi-truck brake shoe riveter, according to claim 1, wherein the rams include two pairs of the rams.

8. The semi-truck brake shoe riveter, according to claim 1, wherein each of the brake shoe tables are rivetted to each of the brake shoes.

9. The semi-truck brake shoe riveter, according to claim 1, wherein the brake shoe table includes a curved body, a pair of hooked ends, and a first plurality of holes.

10. The semi-truck brake shoe riveter, according to claim 1, wherein the first holes are disposed in a predetermined pattern that receive the rivets to be rolled, torqued, or crimped to rivet the brake shoe table and the brake shoe together.

11. The semi-truck brake shoe riveter, according to claim 1, wherein the curved body has a first end and a second end.

12. The semi-truck brake shoe riveter, according to claim 11, wherein the pair of hooked ends are disposed on the first end and the second end of the curved body.

13. The semi-truck brake shoe riveter, according to claim 12, wherein the pair of hooked ends each have a pair of hooks that attach the brake shoe table to the machine carriage of the semi-truck brake shoe riveter.

14. The semi-truck brake shoe riveter, according to claim 1, wherein each of the brake shoe tables and each of the brake shoes are identically curved so that the brake shoe tables and the brake shoes are flush against each other.

15. The semi-truck brake shoe riveter, according to claim 1, wherein there are four of the automated riveter anvils.

16. The semi-truck brake shoe riveter, according to claim 1, wherein there are four of the brake shoe tables.

17. The semi-truck brake shoe riveter, according to claim 1, wherein the automated riveter anvil includes a pneumatic cylinder, a cylinder adaptor, an anvil shaft, and a spring.

18. The semi-truck brake shoe riveter, according to claim 17, wherein the cylinder adaptor is disposed into the pneumatic cylinder.

19. The semi-truck brake shoe riveter, according to claim 18, wherein the anvil shaft extends vertically from the cylinder adaptor to make contact with the ram at the distal end of the anvil shaft.

20. The semi-truck brake shoe riveter, according to claim 19, wherein the spring disposed below the pneumatic cylinder is disposed in front of the anvil shaft to provide tension to the anvil shaft and a distal anvil surface.
